(19) United States
(12) Patent Application Publication
(10) Pub. No.: US 2026/0184651 A1
(43) Pub. Date: Jul. 2, 2026

(54) APPARATUS FOR RECYCLING ORGANIC WASTE

(71) Applicant: Karl Theodor HECKER, Schwalmtal (DE)

(72) Inventor: Karl Theodor HECKER, Schwalmtal (DE)

(21) Appl. No.: 18/864,255

(22) PCT Filed: May 13, 2023
(86) PCT No.: PCT/DE2023/000031

§ 371 Date: Nov. 8, 2024

(30) Foreign Application Priority Data
May 14, 2022 (DE) 10 2022 001 559.5

(51) Int. Cl. C05F 17/971; B02C 4/42

(52) U.S. Cl. CPC C05F 17/971; B02C 4/42

(57) ABSTRACT

An apparatus for recycling organic wastes, characterized in that the apparatus includes at least one receiving container (1) for the organic wastes, wherein the organic waste is passed through at least one comminution unit (6); and the comminution unit (6) is driven by inflowing water.

### CROSS-REFERENCE TO RELATED APPLICATIONS

This application is a National Stage application of International Patent Application No. PCT/DE 2023/000031, filed on May 13, 2023, which claims priority to German Patent Application No. 10 2022 001 559.5, filed on May 14, 2022, each of which is hereby incorporated by reference in its entirety.

### TECHNICAL FIELD

The invention relates to an apparatus and a method for recycling organic wastes.

### BACKGROUND OF THE INVENTION

The recycling of organic wastes is a common and well-known method for fertilizing and preparing arable, plantable areas and cultivation containers. In most cases, chemically produced fertilizers and fertilizing agents are also used, which are intended to stimulate and promote growth. The disadvantage of these fertilizers is well known and should give food for thought to anyone who reads the warnings on the packaging. In this case, the user is warned against skin contact and ingestion in any form. Furthermore, a prohibition notice, namely against discharging the substances into waste water and open waters, will be clearly visible on the packaging. Last but not least, and certainly very intimidating, is the warning: “Keep out of the reach of children and animals.” Fertilizing agents are therefore hazardous chemical substances that are harmful to health and can also contaminate the environment. Electrically operated machines and energy-consuming irrigation systems are used to introduce these “dangerous goods” into the soil. The present invention departs from this way of aiding flora growth and preparing soil and presents an environmentally friendly and sustainable apparatus.

### SUMMARY

The object of the present invention is therefore to provide an organic waste processing apparatus that operates without chemical additives and without an artificially generated energy supply.

This object is achieved by an apparatus for recycling organic wastes that is characterized in that the apparatus comprises at least one receiving container for the organic wastes, wherein the organic waste is passed through at least one comminution unit, and the comminution unit is driven by inflowing water.

The organic wastes, which consist for example of everyday kitchen wastes, are placed in the receiving container. In the next step, soil areas are intended to be prepared in an ecological and nature-protecting manner. For this purpose, water is fed into the apparatus via a water inlet. The water pressure moves the comminution unit, which then comminutes the organic wastes. In a particular embodiment of the present invention, parts of the comminution unit are roller-shaped, wherein the design in the form of at least two rollers that rotate with or counter to one another is of course also included.

In a further embodiment of the present invention, the organic waste is brought to and pressed against the comminution unit with the aid of a transport apparatus. The transport apparatus, in a simple design in the form of a feed pressure (transport) plate, is also moved by the existing water pressure. A further external energy supply, e.g., in the form of electrical energy, is not necessary. Hydropower alone is sufficient to operate the apparatus. Of course, it should also be noted that the water can and should be used to irrigate the soil area to be treated, since the water contains valuable dissolved ingredients from the comminuted organic waste. The organic waste is therefore used in its most suitable form, namely as comminuted fertilizer, as is the driving means of the apparatus, the water. There are therefore no harmful residues.

The comminution unit itself or parts thereof can be roller-shaped. However, there are also non-roller-shaped comminution units that can serve the same purpose. They can be equipped with cutting edges, knives, blades or other devices to perform a further comminuting function in addition to the squeezing and pressing effect. This is already known in principle in the prior art. For example, rollers with a helical coil are used in order to be able to draw in the organic material better. The comminution units can not only be arranged next to one another to create a larger comminution area, but they can also be arranged one below the other. The organic waste is thus passed through multiple comminution units one after the other. This can increase the comminution speed and the effectiveness. Depending on the reinforcement of the comminution units, coarse comminution can be followed by fine comminution. The number of comminution units arranged next to one another, as well as the number of comminution units arranged one above the other, depends only on the geometry of the system in question and can be freely selected. If the comminution units are roller-shaped, this is particularly easy to imagine. The individual rollers are arranged next to one another or one below one another.

Therefore, in a preferred embodiment of the present invention, the number and arrangement of the rollers are such that the organic waste can be optimally comminuted. In this case, it is advantageous if the apparatus is designed such that the comminution units, in particular the roller-shaped comminution units, can be exchanged. The comminution units can therefore be adapted to the consistency and type of organic waste. For instance, vegetable scraps offer a different resistance than nutshells or similar. Such an adjustment optimizes the comminution process and thus saves time and energy. The exchangeability of the individual comminution units can be ensured by suspending them individually in a frame designed for this purpose.

The frame, i.e., the holding module, is designed such that it can be inserted into the receiving container. The frame itself can then be equipped with inserts and support surfaces into which the comminution units are placed. The support surfaces and/or inserts are standardized so that the comminution units can be placed or pushed therein in an exactly fitting manner. Simply put: any comminution unit can be accommodated by the frame. The individual design of the comminution unit is unimportant here. For instance, the comminution unit can be equipped with knives and it can be reinforced with hemispherical surface bulges. Or it is provided with a smooth surface and simply crushes the organic waste. The feed pressure plate not only serves to transport the organic waste to the comminution unit but also compresses the organic waste. This compression process can be enhanced with the aid of a further pressure plate, which is located on the other side of the comminution units. This increases the holding capacity of the receiving container and thus of the entire apparatus.

The entire apparatus, not just the receiving container and the holding module, can be constructed from individual modules. Therefore, the apparatus can easily be delivered in its individual parts and assembled on site.

In a particularly preferred embodiment of the present invention, the comminution units are driven via a turbine. The turbine as a rotating flow machine is suitable for driving the comminution units because it can easily receive the inflowing water and then convert it directly into mechanical rotational energy. Here, the water pressure can determine the rotation speed of the comminution units. However, the energy to drive the comminution units can also be provided by another drive system. The use of hydropower has the advantage that the water can be used for irrigation anyway. The entire bio-chopper system therefore operates without leaving any residue. This also corresponds to the basic concept of the inventor, who is interested in the comprehensive use of natural, renewable, local raw materials. The reason for the recycling concept is not only the short transport route of the product, namely the fertilizer, but the findings of bioeconomists that local organic waste is a superior fertilizer to other organic fertilizers were also a driving force for realizing such an invention. Provided that the organic waste regulations are complied with, the use of organic waste as fertilizer is not only environmentally friendly, protecting bodies of water in particular, and logistically clever, but the fertilization results are also outstanding.

The arrangement of the individual components in relation to one another and the functioning of the invention in a specific embodiment are shown below using drawings and examples. This is not intended to be limiting. This is only one possible embodiment of the invention.

### BRIEF DESCRIPTION OF THE DRAWINGS

FIG. 1 is a schematic representation of the receiving container without the frame with the comminution units

FIG. 2 is a schematic representation of the holding module for the comminution units with drive unit

Example 1, filling and starting up the organic waste processing system.

### DESCRIPTION OF THE PREFERRED EMBODIMENTS

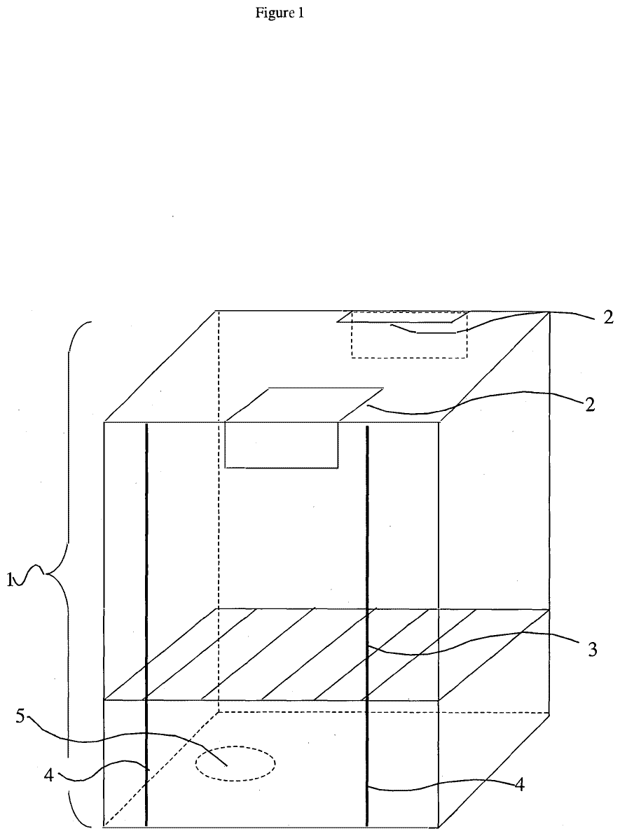

In FIG. 1, the receiving container 1 for recycling the organic wastes can clearly be seen.

The roller-shaped comminution units 6 explained in this embodiment are not shown in this figure. However, the opening 2 into which the roller holding module 7 (frame) with the rollers is to be introduced can be seen. The feed pressure plate 3 that is intended to press the organic waste against the comminution units 6 can also be seen (it is drawn roughly hatched). Also visible are the cheeks 4 for guiding the feed pressure plate 3, with which the organic waste is transported and pressed against the comminution units 6. The structure and arrangement of the individual components of the apparatus according to the invention and their interaction can therefore be clearly seen from FIG. 1. The frame that contains the comminution units 6 is shown in a separate figure. The base plate is provided with a water drain 5 here. This embodiment of the invention shown here has a relatively small receiving container 1, which has dimensions H=250 mm, W=180 mm and D=120 mm and is only intended for everyday kitchen wastes. However, the same model has also been constructed on a much larger scale with a volume of more than 5 m 3 as a further test version. Its orientation changes.

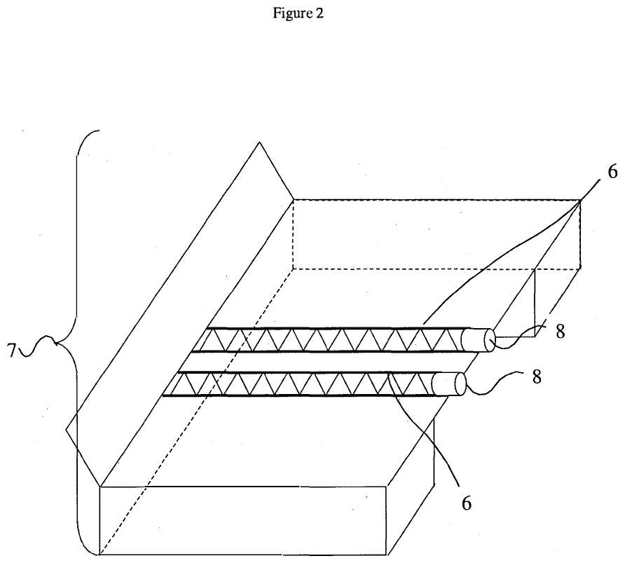

FIG. 2 shows a schematic representation of the holding module 7 for the comminution units with the drive unit 8. The drive unit 8 is shown schematically as a tube in this figure. The orientation of the tube in the figure does not matter for the final orientation of the drive unit 8 (turbine). The frame 7 can be seen, in this case a roller holding module, since the comminution units 6 are roller-shaped. In this FIG. 2, only two roller-shaped comminution units 6 can be seen. These are shown hatched with triangles. However, it is not substantial to the invention whether there are more than two comminution units 6 or whether they are roller-shaped. An increase in the number of comminution units 6 can either increase the comminution area or, when arranged one below the other, improve the degree of comminution. In FIG. 2, the comminution units 6 are rotated via a hydropowered turbine 8. The knife-like choppers on the roller then comminute the organic wastes. The comminution units 6, in this case the rollers equipped with knife-like choppers, are driven via a hydropowered turbine 8. The water pressure is proportional to the rotation speed and to the pressure/cutting force acting on the organic waste. The individual comminution units 6 can each be easily exchanged on the holding frame 7, but other holding modules 7 equipped with differently arranged comminution units 6 can also be inserted into the opening provided for this purpose in the receiving container. This of course also applies to the holding modules 7 that have a different number of comminution units 6.

Example of filling and starting up.

In a first step, the organic waste is introduced into the receiving container 1. The consistency and composition of the organic waste is analyzed and the number and arrangement of the comminution units 6 is determined. This sounds complicated, but with a little practice it can be done in minutes. Now the corresponding holding module 7, which is equipped with the determined number and arrangement of the comminution units 6, is inserted into the opening provided for this purpose in the receiving container. The water inflow is attached so that the turbine 8 can be operated. The water pressure drives the turbine 8, and the comminution units 6 start working. The water pressure continues to press the feed plate 3 with the organic waste against the comminution units 6. The feed pressure plate 3 therefore ensures the transport of the organic waste toward the comminution units 6 on the one hand and on the other hand also provides the pressure for pressing the organic waste against the comminution units 6. The organic waste is now chopped up. In the process, the inflowing water absorbs valuable suspended particles from the organic waste. This water enriched with suspended matter is used to irrigate beds, fields or other cultivated areas. For this purpose, the water can be poured out from an outlet secured with a closure. The closure can be designed as a slider. The chopped-up and comminuted organic waste can be removed from the receiving container 1 and used immediately for fertilization purposes. It should be mentioned again here that only water and waste are used to produce the fertilizer. The organic waste can preferably consist of residual or waste products that arise during food preparation. As already mentioned above, these residues from local regions are particularly effective fertilizing agent. Biocompatibility will probably play a decisive role here.

Further practical improvements include the installation of an automatic water inflow stop, which regulates the water supply when the receiving container 1 is empty or full.

Although various embodiments of the present invention have been described and shown, the invention is not restricted thereto, but may also be embodied in other ways within the scope of the subject-matter defined in the following claims.

What is claimed is:

1. An apparatus for recycling organic wastes, wherein the apparatus comprises at least one receiving container for the organic wastes, wherein the organic waste is passed through at least one comminution unit, and the comminution unit is driven by inflowing water.

2. The apparatus according to claim 1, wherein parts of the comminution unit are roller-shaped.

3. The apparatus according to claim 1, wherein the organic waste is pressed onto the comminution unit with the aid of a (feed pressure) plate, wherein the pressure is generated by the inflowing water.

4. The apparatus according to claim 1, wherein the number and arrangement of the comminution units is designed such that they achieve an optimum degree of comminution.

5. The apparatus according to claim 1, wherein the apparatus is designed such that the comminution units can be exchanged.

6. The apparatus according to claim 1, wherein the comminution units are driven via a turbine.

7. The apparatus according to claim 1, wherein the receiving container has an opening that is suitable for receiving a holding module that is equipped with a selectable number of comminution units, wherein the comminution units can also be arranged differently.

8. The apparatus according to claim 1, wherein the receiving container has a water drain.

9. The apparatus according to claim 2, wherein the organic waste is pressed onto the comminution unit with the aid of a (feed pressure) plate, wherein the pressure is generated by the inflowing water.

10. The apparatus according to claim 2, wherein the number and arrangement of the comminution units is designed such that they achieve an optimum degree of comminution.

11. The apparatus according to claim 3, wherein the number and arrangement of the comminution units is designed such that they achieve an optimum degree of comminution.

12. The apparatus according to claim 2, wherein the apparatus is designed such that the comminution units can be exchanged.

13. The apparatus according to claim 3, wherein the apparatus is designed such that the comminution units can be exchanged.

14. The apparatus according to claim 4, wherein the apparatus is designed such that the comminution units can be exchanged.

15. The apparatus according to claim 2, wherein the comminution units are driven via a turbine.

16. The apparatus according to claim 3, wherein the comminution units are driven via a turbine.

17. The apparatus according to claim 4, wherein the comminution units are driven via a turbine.

18. The apparatus according to claim 5, wherein the comminution units are driven via a turbine.
